(19) United States
(12) Patent Application Publication
(10) Pub. No.: US 2019/0063382 A1
(43) Pub. Date: Feb. 28, 2019

(54) SILENCER SYSTEMS AND ASSEMBLIES

(71) Applicant: CUMMINS INC., Columbus, IN (US)

(72) Inventor: Thomas B. Neeld, Newport Coast, CA (US)

(73) Assignee: CUMMINS INC., Columbus, IN (US)

(21) Appl. No.: 16/033,599

(22) Filed: Jul. 12, 2018

Related U.S. Application Data
(60) Provisional application No. 62/548,625, filed on Aug. 22, 2017.

(51) Int. Cl. F02M 35/12; F02M 35/10

(52) U.S. Cl. CPC F02M 35/1255; F02M 35/10157

(57) ABSTRACT

Silencer device and assemblies for connection to engines are disclosed. Exemplary silencer devices for connection to an air compressor inlet tube may include at least a first quarter wave silencer and a second quarter wave silencer, and a tube assembly comprising a first landing and a second landing, wherein the first quarter wave silencer extends from the first landing and the second quarter wave silencer extends from the second landing.

### CROSS-REFERENCE TO RELATED APPLICATIONS

This application claims priority to U.S. Provisional Application Ser. No. 62/548,625, filed on Aug. 22, 2017, the entire disclosure of which is hereby expressly incorporated by reference.

### FIELD OF THE DISCLOSURE

This disclosure relates to silencer systems and assemblies. More specifically, this disclosure relates to silencer assemblies for engines, such as for connection to an air compressor.

### BACKGROUND

In engines, such as diesel engines, air inlets may be boosted through turbo chargers and/or may use naturally aspirated or uncompressed systems. In some engines, naturally aspirated or uncompressed systems may have an added advantage of achieving better fuel economy than their turbocharged counterparts.

However, in some naturally aspirated or uncompressed engines, the noise produced exterior of the engine compartment (e.g., in the vehicles cab or passenger compartment) may increase. Noise vibration harshness (NVH) is often seen as undesirable and is often sought to be minimized, where possible. Thus, while some naturally aspirated engines may have improved fuel economy, the NVH produced therefrom can be undesirable and/or not acceptable to some customers and/or some end users.

However, many conventional on-engine silencers may require redesign of the engine or vehicle chassis to house such conventional silencers, which may be either impractical and/or cost-prohibitive.

A need therefore exists to practically and cost-effectively address issues of decreasing or silencing the levels of NVH, such as with naturally aspirated engines, preferably without the need for redesign or repositioning of engines within the chassis. Thus, cost-effective on-engine or engine-mounted solutions are needed to address NVH issues.

### SUMMARY

Disclosed herein are various silencer devices for decreasing noise vibration harshness (NVH) of engines and engine system components. The silencers may be tuned for sounds having various frequencies in the audible range.

In some embodiments, silencer devices for connection to an air compressor inlet tube may include at least a first quarter wave silencer and a second quarter wave silencer, and a tube assembly comprising a first landing and a second landing, wherein the first quarter wave silencer extends from the first landing and the second quarter wave silencer extends from the second landing.

In various embodiments, silencer devices may include at least a first quarter wave silencer and a second quarter wave silencer, and a tube assembly comprising a first landing and a second landing, wherein the first quarter wave silencer has a proximal end configured to couple to the first landing and the second quarter wave silencer has a proximal end configured to couple to the second landing.

In some embodiments, at least one of the first quarter wave silencer or the second quarter wave silencer may be reversibly coupled to the tube assembly. Various embodiments of at least one of the first quarter wave silencer or the second quarter wave silencer include silencers where a distal end is closed. The closing is not particularly limited and may include closing with a plug, a cap, a crimp (e.g., where the crimp is molded on the mandrel), or a combination thereof.

The material is not particularly limited and may include plastics, metals, or combinations thereof.

In one embodiment of the present disclosure, a silencer device is provided for connection to an air compressor. The silencer device includes a first quarter wave silencer. a second quarter wave silencer, and a tube assembly comprising a first landing and a second landing. The first quarter wave silencer extends from the first landing and the second quarter wave silencer extends from the second landing.

In one example, the tube assembly and at least one of: the first quarter wave silencer or the second quarter wave silencer form a single integral piece.

In another example, at least one of: the first quarter wave silencer or the second quarter wave silencer is configured to be coupled to the tube assembly. In a variation, at least one of: the first quarter wave silencer or the second quarter wave silencer is configured to be reversibly coupled to the tube assembly.

In yet another example, a distal end of at least one of: the first quarter wave silencer or the second quarter wave silencer is closed.

In still another example, a material of at least one of: the first quarter wave silencer or the second quarter wave silencer is homogeneous. In a variation, the material of at least one of: the first quarter wave silencer or the second quarter wave silencer comprises a plastic, a metal, or combinations thereof. In a further variation, the plastic includes material selected from the group consisting of: a thermoplastic, a thermoset, or combinations thereof.

In yet still another example, a length of at least one of: the first quarter wave silencer or the second quarter wave silencer is ranged between about 300 mm and about 600 mm. In a variation, the length of the first quarter wave silencer is ranged between about 320 mm and about 400 mm and the length of the second quarter wave silencer is ranged between about 450 mm and about 490 mm.

In a further example, at least one of: the first quarter wave silencer or the second quarter wave silencer is tuned for a frequency having a range between about 20 Hz and about 20,000 Hz. In a variation, at least one of: the first quarter wave silencer or the second quarter wave silencer is tuned for the frequency having the range between about 200 Hz to about 300 Hz.

In a yet further example, the first quarter wave silencer is tuned for a first frequency having a first range between about 260 Hz and 290 Hz and the second quarter wave silencer is tuned for a second frequency having a second range between about 200 Hz to about 220 Hz.

In another embodiment of the present disclosure, a silencer device used in an engine is provided, and includes a tube assembly having: an inlet fluidly connected to an engine manifold, an outlet fluidly connected to an air compressor, and a first landing fluidly connected to the tube assembly closer to the outlet of the tube assembly than the inlet of the tube assembly. Also included in the silencer device is a first silencer having a proximal end and a distal end, the proximal end fluidly connected to the first landing of the tube assembly and the distal end being closed.

In one example, the first silencer has an end transformation that gradually reduces a size of the end transformation in diameter until terminating in the distal end of the first silencer. In a variation, an internal diameter of the distal end of the first silencer near the end transformation is smaller than a proximal end of the first quarter wave silencer.

In another example, an internal diameter of the proximal end of the first silencer is substantially consistent with the internal diameter of the distal end of the first silencer that is closed.

In yet another example, a thickness of a wall of the first silencer is between about 1 mm and about 10 mm. In a variation, the thickness of the wall of the first silencer is greater than about 3 mm, or has a first range between about 2 mm and about 7 mm or a second range between about 3 mm and about 5 mm.

In still another example, a sound attenuation is performed by the first silencer tuned based on a frequency of noise generated by the engine, a speed of sound, and a length of the first silencer.

While multiple embodiments are disclosed, still other embodiments of the present disclosure will become apparent to those skilled in the art from the following detailed description, which shows and describes illustrative embodiments of the present disclosure. Accordingly, the drawings and detailed description are to be regarded as illustrative in nature and not restrictive.

### BRIEF DESCRIPTION OF THE DRAWINGS

The above mentioned and other features and objects of this disclosure, and the manner of attaining them, will become more apparent and the disclosure itself will be better understood by reference to the following description of exemplary embodiments of the disclosure taken in conjunction with the accompanying drawings, wherein:

FIG. 1A is an expanded perspective view of a silencer device assembly with an air compressor for use in an engine;

FIG. 1B illustrates an integrated silencer device assembly where the first quarter wave silencer and the second quarter wave silencer form a single integrated piece;

FIG. 2 is a cross-sectional view of the distal end portion of a quarter wave silencer;

FIG. 3A is a graph of exemplary noise data with an air compressor running; and

FIG. 3B is a graph of exemplary noise data with an air compressor off

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates exemplary embodiments of the disclosure, in various forms, and such exemplifications are not to be construed as limiting the scope of the disclosure in any manner.

### DETAILED DESCRIPTION

The embodiments disclosed below are not intended to be exhaustive or limit the disclosure to the precise form disclosed in the following detailed description. Rather, the embodiments are chosen and described so that others skilled in the art may utilize their teachings.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

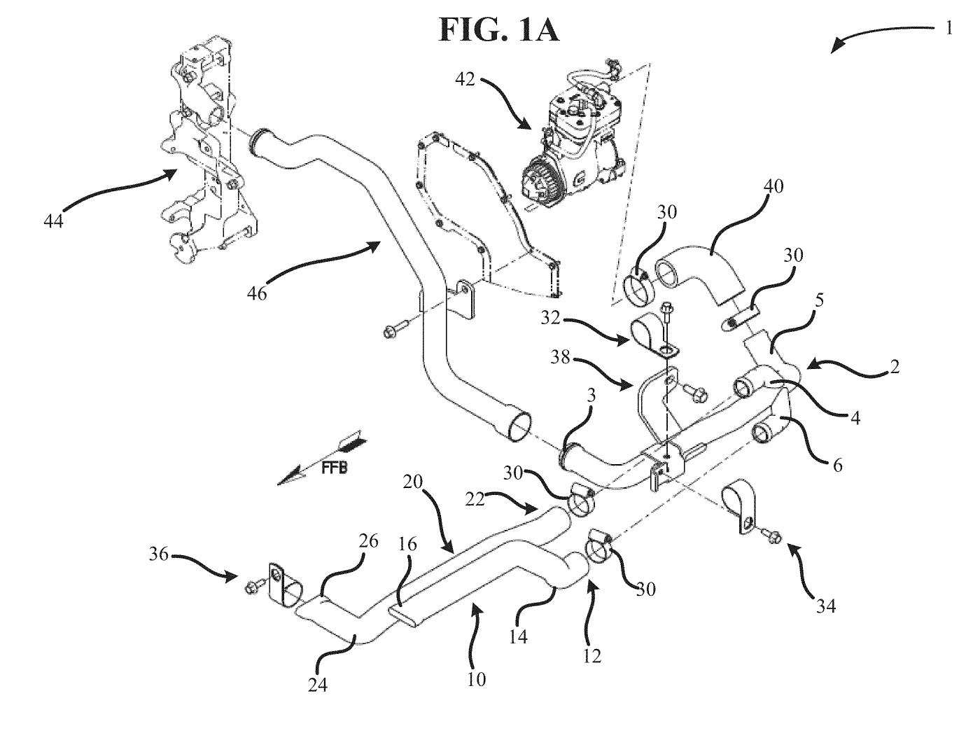

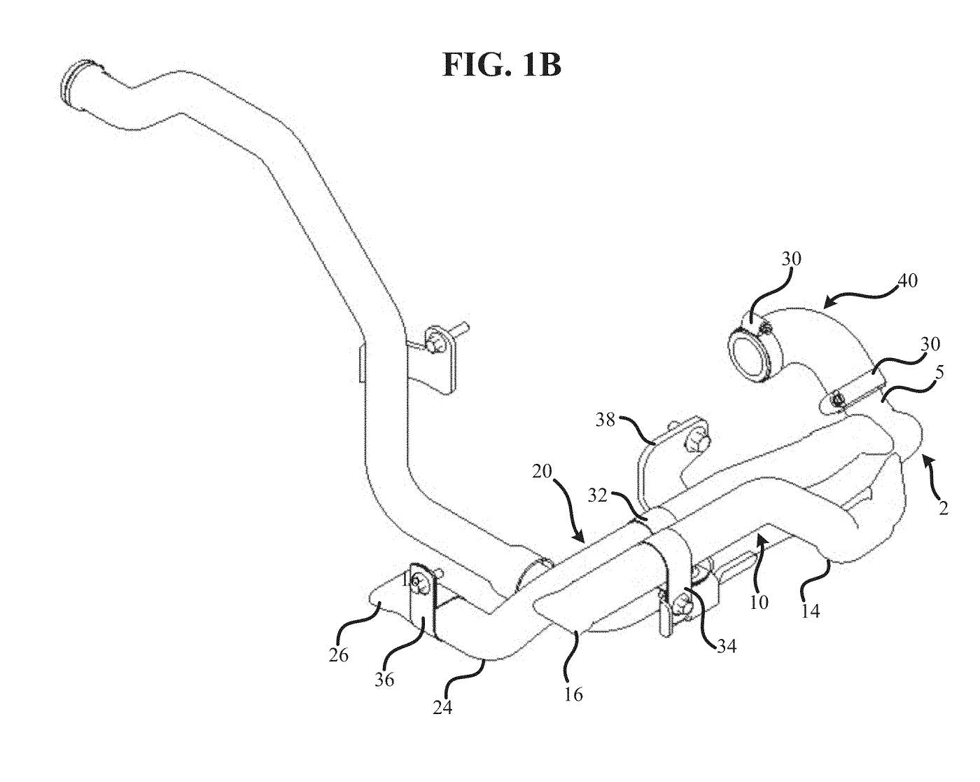

As discussed above, engines, such as those that are naturally aspirated, may have increased noise levels associated. FIG. 1A illustrates an exemplary silencer device for connection with an air compressor. FIG. 1A shows an expanded view of silencer assembly 1, which may include tube assembly 2. In some embodiments, tube assembly 2 may have a first landing 6 and a second landing 4, from which first quarter wave silencer 10 and second quarter wave silencer 20 may extend respectively.

For example, in some embodiments, the tube assembly and at least one of the first quarter wave silencer 10 or the second quarter wave silencer 20 may form a single integral piece. For example, FIG. 1B, shows an exemplary embodiment where both the first quarter wave silencer 10 and the second quarter wave silencer 20 form a single integrated piece with tube assembly 2.

In other embodiments, such as the embodiments shown in FIG. 1A, the silencer assembly may be configured to couple to a first quarter wave silencer 10 and a second quarter wave silencer 20. In some embodiments, the first quarter wave silencer 10 and/or second quarter wave silencer 20 may be either irreversibly (e.g., bonded or welded) or reversibly coupled to the tube assembly 2 (e.g., with the use of hose clamps). For example, in FIG. 1A, first quarter wave silencer 10 and second quarter wave silencer 20 are shown as being configured to be reversibly coupled with first landing 6 and second landing 4. First quarter wave silencer proximal end 12 is shown as being configured to reversibly couple with first landing 6 and second quarter wave silencer proximal end 22 as being configured to reversibly couple with second landing 4 with hose clamps 30. In some embodiments, it may be preferable to have reversible coupling to facilitate repairs or engine retrofits.

As shown in FIG. 1A, engine manifold portion 44 may be connected to air inlet tube 46, which may be connected to inlet 3 of tube assembly 2. In fluid communication, air may flow through air inlet tube 46, through inlet 3, through tube assembly outlet 5, and through elbow 40 and into compressor 42. In the embodiment shown in FIG. 1A, the air compressor 42 and elbow 40 may be connected by hose clamp 30. Mounting brackets 32, 34, 36, and 38 may be used to position the silencer system 1 on the engine (a majority of which is not shown for clarity of the assembly), to create an on-engine assembly.

In some embodiments and as shown in FIG. 1A, the first landing 6 and the second landing 4 may be attenuated at the same point or, in other words, located at the same longitudinal distance from the air compressor 42 along inlet tube assembly 2. In some embodiments, the landings 4, 6 may be located or attenuated at different distances from air compressor 42. In various embodiments, it may be desirable or preferred to locate the first landing 6 and/or the second landing 4 as close to the outlet 5 as possible. In some embodiments, the first quarter wave silencer 10 and/or the second quarter wave silencer 20 may have various bends or angles (e.g., shown as first bend 14 and second bend 24 respectively) to optimize engine placement and/or access.

FIG. 1A illustrates an exemplary embodiment where first quarter wave silencer 10 and/or the second quarter wave silencer 20 have their respective distal ends (16 and 26 respectively) closed. In various embodiments, the closing of the quarter wave silencers is not particularly limited and they may be closed with a plug, a cap, a crimp, or a combination thereof. For example, FIG. 1A illustrates where both the distal end 16 of the first quarter wave silencer 10 and the distal end 26 of the second quarter wave silencer 20 are crimped.

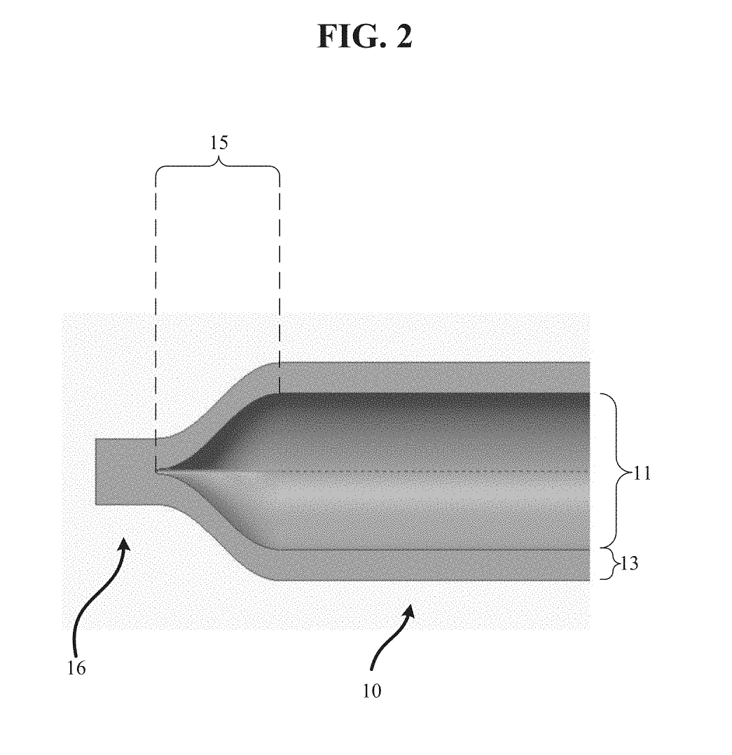

For example, with reference to FIG. 2, a cross-section along the longitudinal portion of distal end 16 is illustrated. Distal end 16 is illustrated as being crimped, where the end crimping is molded onto the quarter wave silencer 10 to form a homogeneous quarter wave silencer. In various embodiments, the crimped end form may be clamped before curing of the tube on the mandrel and, thus, may result in a material that is homogeneous throughout the closed portion after the curing process is complete.

In some embodiments, the end transformation 15 may gradually reduce in diameter until terminating in distal end 16. Thus, in some embodiments, an internal diameter of a distal portion of the first quarter wave silencer 10 or the second quarter wave silencer 20 may be smaller than a proximal portion of the first quarter wave silencer 10 or the second quarter wave silencer 20. Also, in other various embodiments, the internal diameter 11 may be consistent until reaching the end transformation 15. For example, the internal diameter 11 may be substantially consistent until reaching the distal portion closed by either a plug and/or a cap.

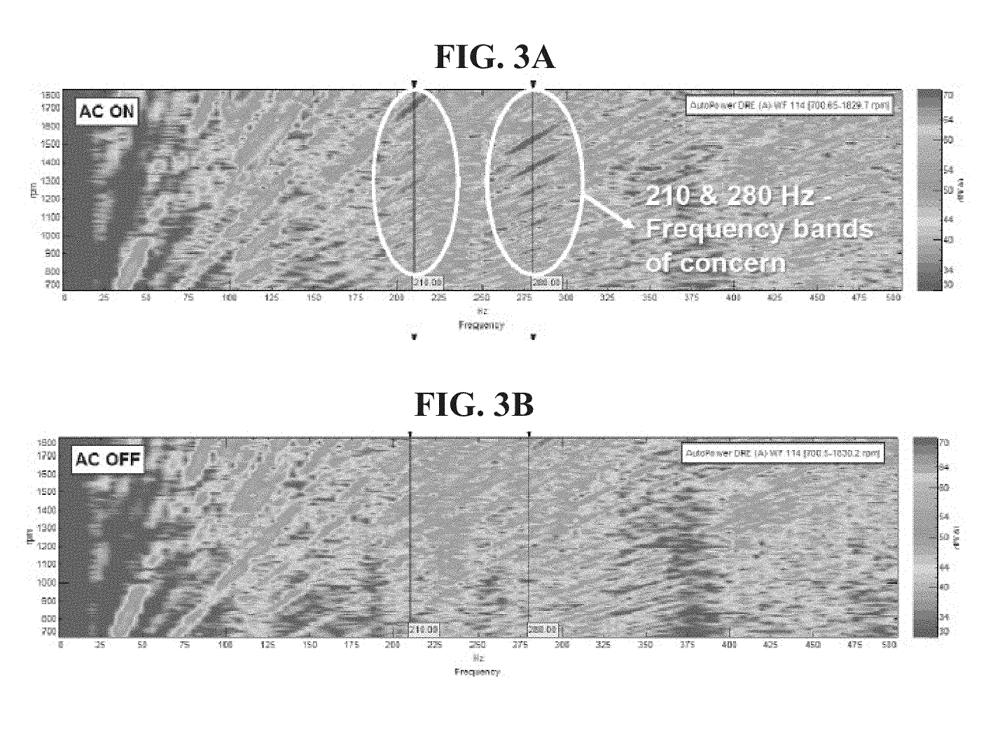

The size and length of the first quarter wave silencer 10 and/or the second quarter wave silencer 20 may be tuned to cancel out a specific sound, which may include a single or multiple frequencies. In some embodiments, the silencer may be tuned for a frequency within the human audible range (between about 20 Hertz (Hz) and about 20,000 Hz), for example between about 200 Hz and about 300 Hz. For example, in some embodiments, the first quarter wave silencer may be tuned for a first frequency between about 260 Hz and 290 Hz and the second quarter wave silencer may be tuned for a second frequency between about 200 Hz and about 220 Hz. For example, FIGS. 3A and 3B illustrate various engine noises with the air compressor on (FIG. 3A) and with the air compressor off (FIG. 3B). As can be seen in FIG. 3A, there is significant noise creation with an air compressor running at both around 210 Hz and 280 Hz. Thus, two quarter wave silencers can be tuned for these two frequencies: one for the 210 Hz and another for the 280 Hz.

To facilitate the attenuation of frequencies, for example, the two described above, the quarter wave attenuation function may be used:

f_{r=C}/4L_{b}

where fᵣ is the frequency, C is the speed of sound (340 m/s), and L_{b} is the length of the silencer.

The length of the first quarter wave silencer 10 or the second quarter wave silencer 20 is not particularly limited. A person of ordinary skill in the art, with the benefit of this disclosure, will recognize that various diameters, lengths, and thicknesses can be used to provide the proper attenuation of sound or sounds produced by the engine. In various embodiments, the first quarter wave silencer 10 or the second quarter wave silencer 20 may be between about 300 millimeter (mm) and about 600 mm long. For example, in some embodiments, the length of the first quarter wave silencer is between about 320 mm and about 400 mm and the length of the second quarter wave silencer is between about 450 mm and about 490 mm. Exemplary thicknesses of the wall 13 may include ranges between about 1 mm and about 10 mm, between about 2 mm and about 7 mm, 3 mm to about 5 mm, or greater than about 3 mm.

The material of the first quarter wave silencer 10 or the second quarter wave silencer 20 is not particularly limited and may include a plastic, a metal, or combinations thereof. Exemplary plastic include materials such as thermoplastics, thermosets, or combinations thereof. In various combinations of materials, the materials may be homogeneous mixtures or heterogeneous mixtures.

Suitable thermoplastics may include acrylics, acrylonitrile butadiene styrene, nylon, polylactic acid, polybenzimidazole (PBI), polycarbonate, polyether sulfone (PES), polyetheretherketone (PEEK), polyetherimide (PEI), polyethylene, polyphenylene oxide (PPO), polyphenylene sulfide (PPS), polypropylene (PP), polystyrene, polyvinyl chloride (PVC), polytetrafluoroethylene (PTFE), or combinations thereof.

Suitable thermosets in various embodiments may include polyester resin fiberglass, polyurethanes, polyurea, polyurethane, vulcanized rubbers, phenol-formaldehyde resins, duroplast, urea-formaldehyde foams, melamine resins, diallyl-phthalate (DAP), ethylene propylene diene monomer (EPDM), epoxy resins, benzoxazines, polyimides, polycyanurates, furan resins, silicone resins, vinyl ester resins, or combinations thereof.

Suitable metals include metals comprising (including) aluminum, steel, brass, copper, nickel, chromium, titanium, zinc, cobalt, molybdenum, alloys thereof, or combinations thereof.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A silencer device for connection to an air compressor comprising:
a first quarter wave silencer;
a second quarter wave silencer; and
a tube assembly comprising a first landing and a second landing, wherein
the first quarter wave silencer extends from the first landing and the second quarter wave silencer extends from the second landing.

2. The silencer device of claim 1, wherein the tube assembly and at least one of: the first quarter wave silencer or the second quarter wave silencer form a single integral piece.

3. The silencer device of claim 1, wherein at least one of: the first quarter wave silencer or the second quarter wave silencer is configured to be coupled to the tube assembly.

4. The silencer device of claim 3, wherein at least one of: the first quarter wave silencer or the second quarter wave silencer is configured to be reversibly coupled to the tube assembly.

5. The silencer device of claim 1, wherein a distal end of at least one of: the first quarter wave silencer or the second quarter wave silencer is closed.

6. The silencer device of claim 1, wherein a material of at least one of: the first quarter wave silencer or the second quarter wave silencer is homogeneous.

7. The silencer device of claim 5, wherein the material of at least one of: the first quarter wave silencer or the second quarter wave silencer comprises a plastic, a metal, or combinations thereof.

8. The silencer device of claim 7, wherein the plastic includes material selected from the group consisting of: a thermoplastic, a thermoset, or combinations thereof.

9. The silencer device of claim 1, wherein a length of at least one of: the first quarter wave silencer or the second quarter wave silencer is ranged between about 300 mm and about 600 mm.

10. The silencer device of claim 9, wherein the length of the first quarter wave silencer is ranged between about 320 mm and about 400 mm and the length of the second quarter wave silencer is ranged between about 450 mm and about 490 mm.

11. The silencer device of claim 1, wherein at least one of: the first quarter wave silencer or the second quarter wave silencer is tuned for a frequency having a range between about 20 Hz and about 20,000 Hz.

12. The silencer device of claim 11, wherein at least one of: the first quarter wave silencer or the second quarter wave silencer is tuned for the frequency having the range between about 200 Hz to about 300 Hz.

13. The silencer device of claim 1, wherein the first quarter wave silencer is tuned for a first frequency having a first range between about 260 Hz and 290 Hz and the second quarter wave silencer is tuned for a second frequency having a second range between about 200 Hz and about 220 Hz.

14. A silencer device used in an engine, comprising:
a tube assembly having:
an inlet fluidly connected to an engine manifold,
an outlet fluidly connected to an air compressor, and
a first landing fluidly connected to the tube assembly closer to the outlet of the tube assembly than the inlet of the tube assembly;
a first silencer having a proximal end and a distal end, the proximal end fluidly connected to the first landing of the tube assembly and the distal end being closed.

15. The silencer device of claim 14, wherein the first silencer has an end transformation that gradually reduces a size of the end transformation in diameter until terminating in the distal end of the first silencer.

16. The silencer device of claim 15, wherein an internal diameter of the distal end of the first silencer near the end transformation is smaller than a proximal end of the first quarter wave silencer.

17. The silence device of claim 14, wherein an internal diameter of the proximal end of the first silencer is substantially consistent with the internal diameter of the distal end of the first silencer that is closed.

18. The silencer device of claim 14, wherein a thickness of a wall of the first silencer is between about 1 mm and about 10 mm.

19. The silencer device of claim 18, wherein the thickness of the wall of the first silencer is greater than about 3 mm, or has a first range between about 2 mm and about 7 mm or a second range between about 3 mm and about 5 mm.

20. The silencer device of claim 14, wherein a sound attenuation is performed by the first silencer tuned based on a frequency of noise generated by the engine, a speed of sound, and a length of the first silencer.
